(19) United States
(12) Patent Application Publication
(10) Pub. No.: US 2004/0153582 A1
(43) Pub. Date: Aug. 5, 2004

(54) Data processor and memory card

(75) Inventors: Hidemi Oyama, Chitose (JP); Michio Onda, Kodaira (JP); Kazuhiro Tomonaga, Akishima (JP); Hideo Sato, Tachikawa (JP)

Correspondence Address: MILES & STOCKBRIDGE PC, 1751 PINNACLE DRIVE, SUITE 500, MCLEAN, VA, 22102-3833, US

(73) Assignees: Renesas Technology Corp.; Renesas Northern Japan Semiconductor, Inc.

(21) Appl. No.: 10/714,936

(22) Filed: Nov. 18, 2003

(30) Foreign Application Priority Data
Dec. 13, 2002 (JP) 2002-361652

(51) Int. Cl. H04L 1/22

(52) U.S. Cl. 710/15; 714/1

(57) ABSTRACT

The present invention provides a data processor operating in a card host in such a manner as to easily eliminate access errors attributable to propagation delays of a clock signal and data. A memory card interface controller transmits a clock signal to a memory card to acquire read data therefrom in synchronism with the clock signal, the memory card interface controller being switchable between a raising edge and a falling edge of the clock signal when acquiring the read data in synchronous relation with the clock signal. It is possible to adjust a timing of read data acquisition by a half cycle of the clock signal. The memory card interface controller may be switched between different frequencies of the clock signal. Additional switching of frequencies provides more flexibility for timing adjustment.

### BACKGROUND OF THE INVENTION

The present invention relates to a memory card, and a data processor that incorporates a memory card interface controller constituting a memory card host device. More particularly, the invention relates to techniques for clock control and clock frequency control for data acquisition.

A typical clock synchronized memory card receives a transfer clock signal from a memory card host device and outputs read data in synchronism with the transfer clock signal. In turn, the memory card host device acquires the read data in synchronized relation with the transfer clock signal. There exist techniques for this type of timing control, one being disclosed illustratively in Japanese Published Unexamined Patent Application No. Hei 08(1996)-123717. The disclosed technique involves storing beforehand access timing information about different semiconductor memory modules that share a data line or like arrangement, and changing, on the basis of the timing information, the timing of data acquisition or the clock duration on the side of a data transfer destination depending on the semiconductor memory module being accessed. More specifically, the technique involves adjusting the timing of reading data by switching the phase of the clock signal fed to the memory by use of software.

### SUMMARY OF THE INVENTION

The inventors of this invention have studied clock synchronization implemented by clock synchronized memory cards and by memory card host devices for use therewith. It has been found that one type of memory card outputs read data in synchronism with a raising edge of the clock signal, while another type of memory card outputs read data in synchronization with a falling edge of the clock signal. It has also been revealed that one type of memory card host device acquires read data in synchronized relation with the raising edge of the clock signal, another type with the falling edge of the clock signal. Because there are delays involved in the propagation of the clock signal and read data between the memory card host device and the memory card, the inventors have found that the normal data read operation cannot be guaranteed for a certain combination of a memory card and a card host. The higher the clock signal frequency is, the smaller is the operational allowance of the memory-host combination for the propagation delays involved.

It is therefore an object of the present invention to overcome the above and other deficiencies of the related art and to provide a data processor operating in a memory card host device in such a manner as to easily eliminate access errors attributable to propagation delays of a clock signal and data.

It is another object of the present invention to provide a memory card capable of easily eliminating access errors attributable to propagation delays of the clock signal and data.

Further objects and advantages of this invention will become apparent upon a reading of the description of this specification and appended drawings.

In achieving the foregoing and other objects of the present invention and according to a first aspect thereof, there is provided a data processor comprising a central processing unit and a memory card interface controller connectable to a clock synchronized memory card, wherein the memory card interface controller transmits a clock signal to the memory card to acquire read data therefrom in synchronism with the clock signal, the memory card interface controller being switchable between a raising edge and a falling edge of the clock signal when acquiring the read data in synchronous relation with the clock signal. It is possible to adjust the timing of read data acquisition by a half cycle of the clock signal.

The memory card interface controller may be switched between different frequencies of the clock signal. The additional switching of frequencies provides more flexibility for timing adjustment.

As a way of timing adjustment, the central processing unit may switch between the raising edge and the falling edge of the clock signal in response to a data read error during read data acquisition in synchronism with the clock signal. Alternatively, the central processing unit may switch from a high frequency to a low frequency of the clock signal in response to a data read error. As another alternative, the central processing unit may switch between the raising edge and the falling edge of the clock signal in response to a data read error during read data acquisition in synchronism with the clock signal, the central processing unit further switching from a high frequency to a low frequency of the clock signal in response to a data read error following the switching between the raising edge and the falling edge of the clock signal. As a further alternative, the central processing unit may switch from a high frequency to a low frequency of the clock signal in response to a data read error, the central processing unit further switching between the raising edge and the falling edge of the clock signal in response to a data read error after the frequency switching during read data acquisition in synchronism with the clock signal.

For timing adjustment, the data processor may further comprise first and second registers accessible by the central processing unit. The first register may be loaded with control data for determining whether the read data is to be acquired in synchronism with the raising edge or with the falling edge of the clock signal. The second register may be loaded with control data for determining whether the clock signal is to have a high frequency or a low frequency.

Operations on the first and the second registers may be executed by software. In that case, the data processor may further comprise a nonvolatile memory which is electrically rewritable and which serves as a storage area for accommodating a control program executed by the central processing unit in order to generate the control data.

The memory card interface controller may transmit data to the memory card in synchronism with the clock signal, the memory card interface controller being switchable between the raising edge and the falling edge of the clock signal when transmitting the data in synchronous relation with the clock signal.

According to a second aspect of the invention, there is provided a memory card for receiving a clock signal from a memory card host device and transmitting read data to the memory card host device, wherein the memory card determines whether to synchronize with a raising edge or with a falling edge of the clock signal when transmitting the read data. Operating on the memory card makes it possible to adjust the timing of read data acquisition by the memory card host device. That is, the memory card host device need not have its own hardware for timing adjustment.

The memory card host device may instruct the memory card to determine whether to synchronize with the raising edge or with the falling edge of the clock signal.

The memory card may acquire data from the memory card host device in synchronism with the clock signal, the memory card further determining whether to synchronize with the raising edge or with the falling edge of the clock signal when acquiring the data.

### BRIEF DESCRIPTION OF THE DRAWINGS

FIG. 1 is a block diagram of a data processor embodying this invention;

FIG. 2 is an explanatory view showing how signals are interfaced between a memory card interface controller (MCIFC) and a Multimedia Card (registered trade mark, also called MMC; simply referred to as the M card hereunder) in MMC mode;

FIG. 3 is an explanatory view depicting how signals are interfaced between the MCIFC and the M card in SPI (serial peripheral interface) mode;

FIG. 4 is a timing chart illustrating typical operation timings of read access to the M card in SPI mode;

FIG. 5 is a tabular view indicating typical settings of control data;

FIG. 6 is a schematic block diagram of a different MCIFB;

FIG. 7 is a circuit diagram of a different timing switching circuit;

FIG. 8 is a timing chart presenting typical operation timings in effect when the timing switching circuit of FIG. 7 is used;

FIG. 9 is a block diagram of a memory card embodying this invention;

FIG. 10 is a circuit diagram of a signal acquisition timing switching circuit and a transmission timing switching circuit in the memory card of FIG. 9; and

FIG. 11 is an overall block diagram showing the data processor in more detail.

### DESCRIPTION OF THE PREFERRED EMBODIMENTS

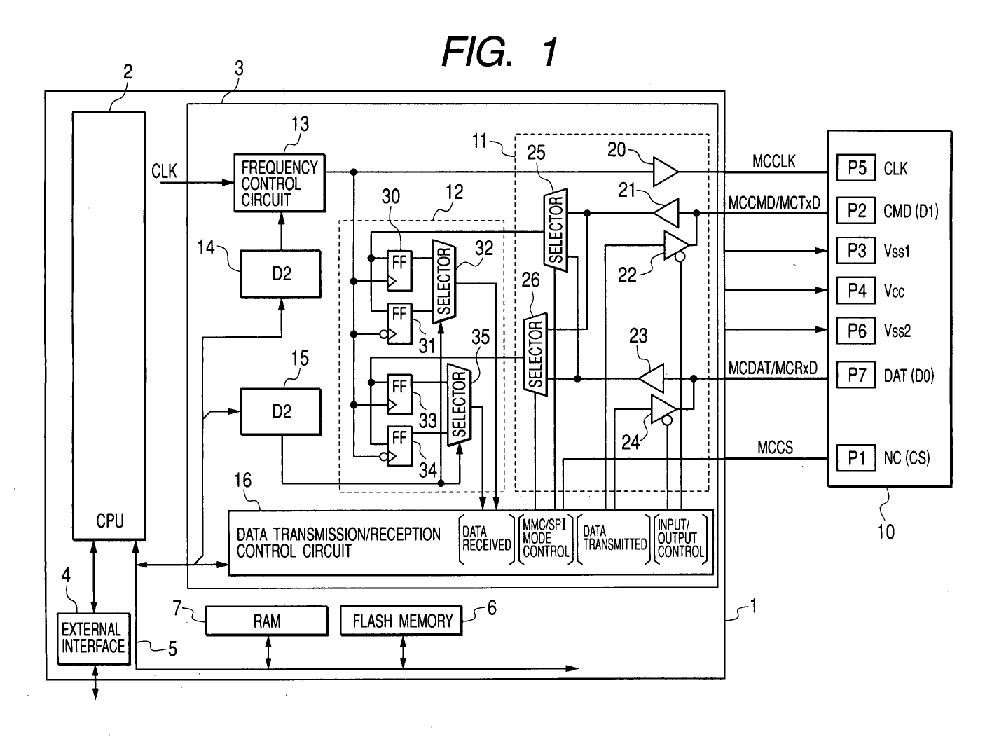

FIG. 1 is a block diagram of a typical data processor 1 embodying this invention. The data processor 1 is formed illustratively by CMOS integrated circuit manufacturing technology on a single-crystal semiconductor substrate (semiconductor chip).

The data processor 1 comprises: a central processing unit (CPU) 2 shown in representative fashion, a memory card interface controller (MCIFC) 3 under control of the CPU 2, and an external interface circuit 4. The CPU 2 and the MCIFC 3 are connected by a bus 5. The bus 5 is connected to an electrically rewritable nonvolatile memory such as a flash memory 6, and a RAM (random access memory) 7 that functions as a work area for the CPU 2.

The MCIFC 3 is connected to a memory card 10 such as a Multimedia Card known as MMC (registered trademark; also called the M card hereunder), and controls interface with that memory card 10 in synchronism with a transfer clock signal MCCLK. As will be discussed later in more detail, the MCIFC 3 may switch between a raising edge and a falling edge of the transfer clock signal MCCLK when acquiring read data from the M card 10. The MCIFC 3 may also switch frequencies of the transfer clock signal MCCLK. The MCIFC 3 is made up of a signal interface block 11, an acquisition timing switching circuit 12, a frequency control circuit 13, control register 14 and 15, and a data transmission/reception control circuit 16.

The signal interface block 11 is connected to the M card 10. The basic specifications of the M card regarding commands, terminal functions, card size, and other related parameters have been stipulated by the MMC Association. According to the basic specifications, the M card 10 has first through seventh external terminals and operates either in MMC mode or in SPI (serial peripheral interface) mode. A plurality of M cards 10 may share a single bus. That is, a large number of M cards 10 may be connected to a single memory card host device which utilizes the data processor 1. The difference between MMC mode and SPI mode lies in two aspects: external interface specifications, and the way of selecting each of the M cards connected.

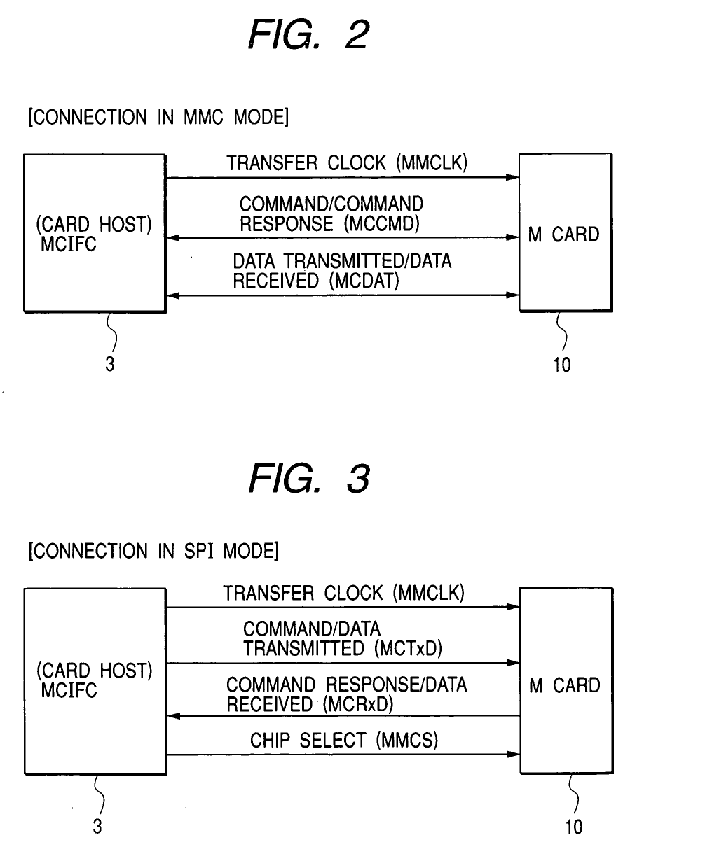

With MMC mode in effect for interfacing to the outside, a first external terminal P1 functions as a reserved terminal NC (left open or fixed to a logical “1”), a second external terminal P2 as a command terminal CMD (for inputting commands and outputting response signals), third and sixth external terminals as circuit ground terminals Vss1 and Vss2, a fourth external terminal P2 as a supply voltage terminal Vcc, a fifth external terminal P5 as a clock input terminal CLK, and a seventh external terminal P7 as a data input/output terminal DAT. FIG. 2 illustrates how signals are interfaced between the MCIFC 3 and the M card 10 in MMC mode. In FIG. 2, MCCLK represents a transfer clock signal; MCCMD denotes a command transmission signal from the MCIFC 3 to the M card 10 and a response signal from the M card 10 to the MCIFC 3; and MCDAT stands for a data signal from the MCIFC 3 to the M card 10 and a data signal from the M card 10 to the MCIFC 3.

With SPI mode in effect, the first external terminal P1 functions as a chip select terminal CS (negative logic), the second external terminal P2 as a data input terminal DI (for inputting data and commands from the card host to the M card 10), the third and the sixth external terminals P3 and P6 as circuit ground terminals Vss1 and Vss2, the fourth external terminal P4 as a supply voltage terminal Vcc, the fifth external terminal P5 as a clock input terminal CLK, and the seventh external terminal P7 as a data output terminal DO (for outputting data and status from the M card 10 to the card host). FIG. 3 shows how signals are interfaced between the MCIFC 3 and the M card 10 in SPI mode. In FIG. 3, MCCLK represents a transfer clock signal; MCTxD denotes a command transmission and a data transmission signal from the MCIFC 3 to the M card 10; MCRxD stands for a command response signal and a data reception signal from the M card 10 to the MCIFC 3; and MCCS represents a chip select signal from the MCIFC 3 to the M card 10.

As a way of selecting one of a plurality of M cards 10 in MMC mode, each card is assigned a specific relative card address (RCA) by a card recognition process. A desired card is selected by having its relative card address designated. The card recognition process proceeds as follows: where M mode is designated for a plurality of M cards connected in common to a bus, the memory card host device (also called the M card host) issues a particular command over a command line (i.e., the signal line to which the command terminal CMD is connected). In turn, the M cards in their ready state start outputting simultaneously card identification information (card identification number or CID) one bit at a time onto the command line. The command line has an open drain architecture, so that an output onto the command line triggers illustratively a low-level or a high-output impedance state. Every time a single bit is output, each M card compares the corresponding bit value of its own card identification information with the command line status. If the comparison results in a mismatch, the M card in question stops outputting the CID and returns to its ready state. Eventually, the memory card having the smallest CID value is allowed to complete its CID value transmission, before going into an identification state. That card in the identification state is assigned an RCA. The recognition process above is repeated until all memory cards are assigned their own RCAs.

In SPI mode, a chip select signal MCCS is connected to the chip select terminal CS of each of the configured cards. Any M card 10 desired to be accessed is selected by having its chip select signal MCCS asserted to the selection level.

An operation mode is set for the M card 10 as follows: if the signal MCCS is at the Low level when fed to the terminal P1 in suitably timed fashion in the card recognition process by the MCIFC 3, then the M card 10 is placed in SPI mode. If the signal MCCS is at the High level, the M card is placed in MMC mode.

The signal interface block 11 includes a clock buffer 20, input buffers 21 and 23, output buffers 22 and 24, and selectors 25 and 26, and is connected to the terminals P5, P2, P7, and P1 of the M card 10. The selective input to the selectors 25 and 26 and the operations on the input buffers 21 and 23 as well as on the output buffers 22 and 24 are controlled in accordance with the operation mode set for the M card 10 by the data transmission/reception control circuit 16 and in keeping with the input/output operations being carried out. That is, with MMC mode set for the M card 10, the output buffer 22 is used for command output; the input buffer 21 is used for command response input; the selector 25 selects the output of the input buffer 21; the output buffer 24 is used for data output; the input buffer 23 is used for data input; and the selector 26 selects the output of the input buffer 23. When SPI mode is set for the M card 10, the output buffer 22 is used for command output and data output; the input buffer 23 is used for command response input and data input; the command response input is forward to a downstream stage through the selector 25; and the data input is transferred to a downstream stage through the selector 26.

The acquisition timing switching circuit 12 has latch circuits (FF) 30 and 31 and a selector 32 connected to the output of the selector 25, and has latch circuits (FF) 33 and 34 and a selector 35 connected to the output of the selector 26. The latch circuits 30 and 33 latch their input in synchronism with a raising edge of the transfer clock signal MCCLK, while the latch circuits 31 and 34 latch their input in synchronization with a falling edge of the transfer clock signal MCCLK. The selector 32 selects the output of either the latch circuit 30 or the latch circuit 31. The selector 35 selects the output of either the latch circuit 33 or the latch circuit 34. The selective operation of the selectors 32 and 35 is determined by the logical value of control data D1 set in the control register 15. When the control data D1 in the control register 15 constitute a logical “1,” the outputs of the latch circuits 30 and 33 are selected. This causes the data transmission/reception control circuit 16 to recognize a command response coming from the selector 25 and received data (i.e., read data from the M card) from the selector 26 in synchronism with a raising edge of the transfer clock signal MCCLK. When the control data D1 in the register 15 denote a logical “0,” the outputs of the latch circuits 31 and 34 are selected. This allows the data transmission/reception control circuit 16 to recognize the command response coming from the selector 25 and the received data (read data from the M card) from the selector 26 in synchronism with a falling edge of the transfer clock signal MCCLK.

The frequency control circuit 13 generates the transfer clock signal MCCLK based on a system clock signal CLK. In accordance with control data D2 set in the control register 14, the frequency control circuit 13 controls the frequency of the transfer clock signal MCCLK. For example, when the control data D2 constitute a logical “1,” the frequency control circuit 13 sets the transfer clock signal MCCLK for a relatively high frequency (the high frequency at, say, 20 MHz); when the control data D2 denote a logical “0,” the frequency control circuit 13 sets the transfer clock signal MCCLK for a relatively low frequency (the low frequency at, say, 15 MHz).

The data transmission/reception control circuit 16 recognizes the M card 10 and establishes the operation mode in response to a set-up command or the like from the CPU 2, and controls access to the M card 10 in response to an access command from the CPU 2. The MCIFC 3 outputs the read data from the M card 10 onto the bus 5, and inputs write data from the bus 5 to the M card 10.

The control registers 14 and 15 are located in the address space of the CPU 2. The control data D1 and D2 are set to the registers 14 and 15 by the CPU 2 executing a suitable control program.

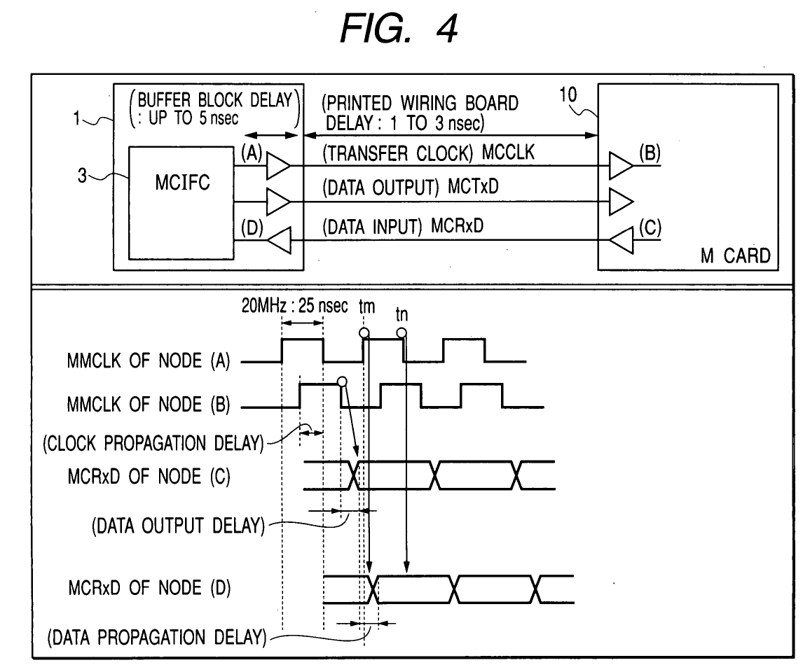

FIG. 4 is a timing chart illustrating typical operation timings of read access to the M card in SPI mode. It is assumed here that the clock signal MCCLK has a frequency of 20 MHz. The transfer clock signal MCCLK develops a clock propagation delay at a receiving end relative to a node (A) on the transmitting side. The M card 10 outputs read data MCRxD from a node (C) onto the bus illustratively in synchronism with a falling edge of the transfer clock signal MCCLK. A data output delay occurs before the data output takes place. A data propagation delay develops over the bus, before the data MCRxD reach an input node (D) of the MCIFC 3. In the example of FIG. 4, the time at which the read data reaches the input node (D) of the MCIFC 3 is near a raising edge of the transfer clock signal MCCLK in the node (A). If the MCIFC 3 acquires the read data in synchronism with the raising edge of the transfer clock signal MCCLK (at time tm), then the read data can be in an indefinite state when latched by the latch circuits possibly resulting in a data error. If, on the other hand, the MCIFC 3 acquires the read data in synchronism with a falling edge of the transfer clock signal MCCLK (at time tn), then the read data are in a definite state when latched by the latch circuits. The latch timing can be changed similarly by altering the frequency of the clock signal MCCLK. The clock signal frequency may be changed from the high frequency to the low frequency or vice versa.

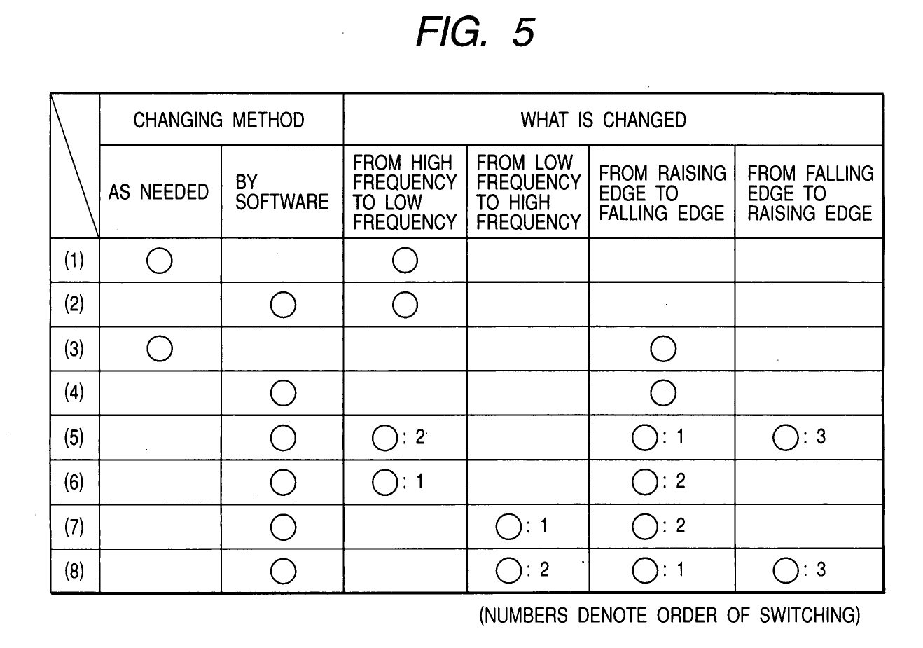

FIG. 5 is a tabular view indicating typical settings of control data. The control data may be changed either automatically by the control program of the CPU 2 or by the user as needed in the system. The control program may be stored in, and retrieved from, a predetermined program area in the flash memory 6 through the external interface 4. The program may also be stored into the flash memory 6 while the data processor 1 is being mounted on the system (i.e., in the on-board state).

The user (i.e., system administrator) may change the control data as needed in the control registers 14 and 15 when recognizing a data error state in the system. In FIG. 5, the settings (1) and (3) of the changing method may be utilized by the user for control data change.

Changing the control data automatically by the program involves illustratively recognizing as a cause for interruption the occurrence of a read error in the read data from them card 10, the error causing the CPU 2 to execute an interrupt handling routine and change the values in the control registers 14 and 15. A read error may be detected illustratively by use of CRC (cycle redundancy check) code or the like attached to the read data. With the change setting (2) above in effect, the high frequency of the transfer clock signal MCCLK is replaced by its low frequency for synchronism in data acquisition. With the setting (4) in use, the raising edge of the transfer clock signal MCCLK is replaced by its falling edge for data acquisition synchronism. Where the setting (5) is in effect, a first data error triggers change from the raising edge of the transfer clock signal MCCLK to its falling edge; a second data error causes switchover from the high frequency of the transfer clock signal MCCLK to its low frequency; and a third data error brings about switching from the falling edge of the transfer clock signal MCCLK to its raising edge, for synchronism in data acquisition. With the setting (6) in use, a first data error triggers change from the high frequency of the transfer clock signal MCCLK to its low frequency, and a second data error causes switchover from the raising edge of the transfer clock signal MCCLK to its falling edge, for data acquisition synchronism. Where the setting (7) is in effect, a first data error brings about change from the low frequency of the transfer clock signal MCCLK to its high frequency, and a second error causes changeover from the raising edge of the transfer clock signal MCCLK to its falling edge, for synchronism in data acquisition. With the setting (8) in use, a first data error triggers change from the raising edge of the transfer clock signal MCCLK to its falling edge; a second data error causes switchover from the low frequency of the transfer clock signal MCCLK to its high frequency; and a third data error brings about switching from the falling edge of the transfer clock signal MCCLK to its raising edge, for data acquisition synchronism.

The data error count is kept by the data transmission/reception control circuit 16 using suitable counter means or flag means. Once set, the control data should preferably remain unchanged in sleep or standby status of the memory card host device unless and until the M card is removed. If power supply is removed or if the M card is replaced, the control registers 14 and 15 are initialized. That is because whether the read data is to be output in synchronism with the raising edge or falling edge of the transfer clock signal depends on the type of the M card being installed.

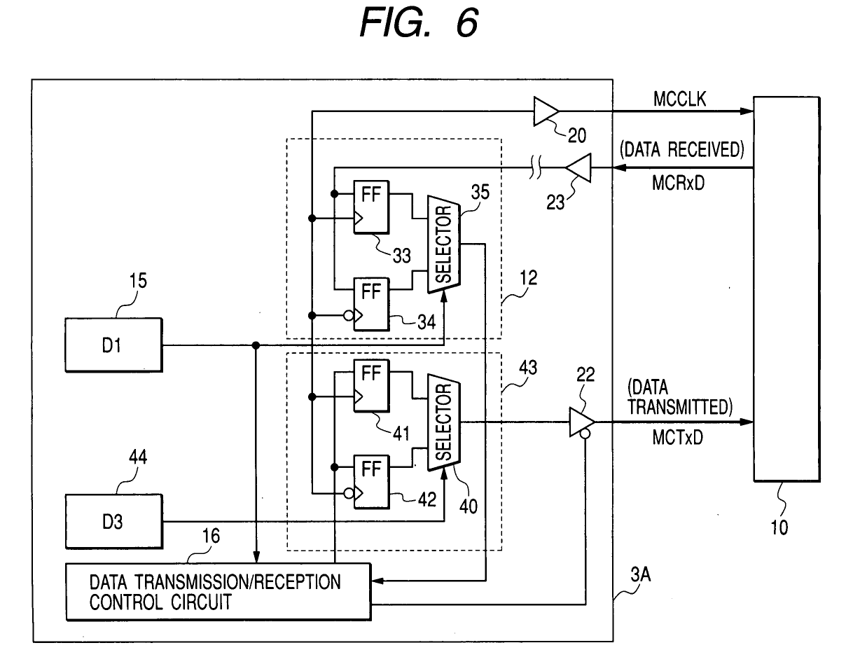

FIG. 6 is a schematic block diagram of a different MCIFB 3A. In this memory card interface controller, the acquisition timing switching circuit 12 for incoming signals is supplemented with a transmission timing switching circuit 43 for outgoing signals. The switching circuit 43 illustratively has latch circuits 41 and 42 and a selector 40 connected upstream of the output buffer 22. The latch circuit 41 latches transmitted data in synchronism with a raising edge of the transfer clock signal MCCLK, while the latch circuit 42 latches transmitted data in synchronous relation with a falling edge of the transfer clock signal MCCLK. The selector 40 selects the output of either the latch circuit 41 or the latch circuit 42 in accordance with the logical value of control data D3 set in a control register 44. This setup makes it possible to handle data errors during data acquisition from the M card 10 through the appropriate setting of the control data D3. It should be noted that FIG. 6 omits some components whose counterparts are shown in FIG. 1.

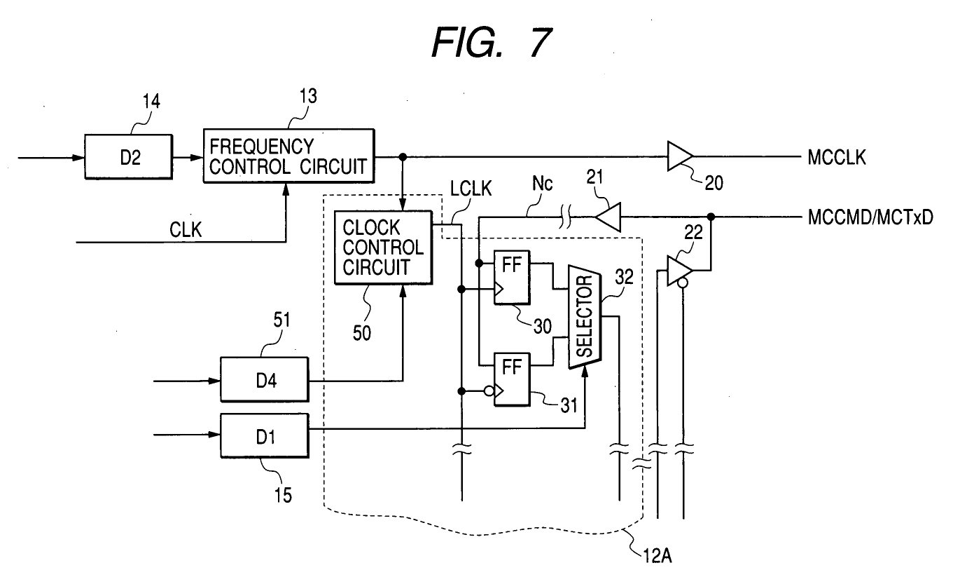

FIG. 7 is a circuit diagram of a different timing switching circuit 12A. In this example, the frequency control circuit 13 divides in two the system clock signal CLK in frequency to generate the transfer clock signal MCCLK. The latch circuits 30 and 31 are fed with a clock signal LCLK generated by a clock control circuit 50. When control data D4 set in a control register 51 represent a logical “1,” the clock control circuit 50 outputs a clock signal LCLK leading the transfer clock signal MCCLK by a phase angle of 180 degrees. When the control data D4 denote a logical “0,” the clock control circuit 50 outputs a clock signal LCLK leading the transfer clock signal MCCLK by a phase angle of 270 degrees. The latch circuit 30 acquires the read data in synchronism with a raising edge of the clock signal LCLK, and the latch circuit 31 acquires the read data in synchronized relation with a falling edge of the clock signal LCLK. The selector 32 selects the output of either the latch circuit 30 or the latch circuit 31.

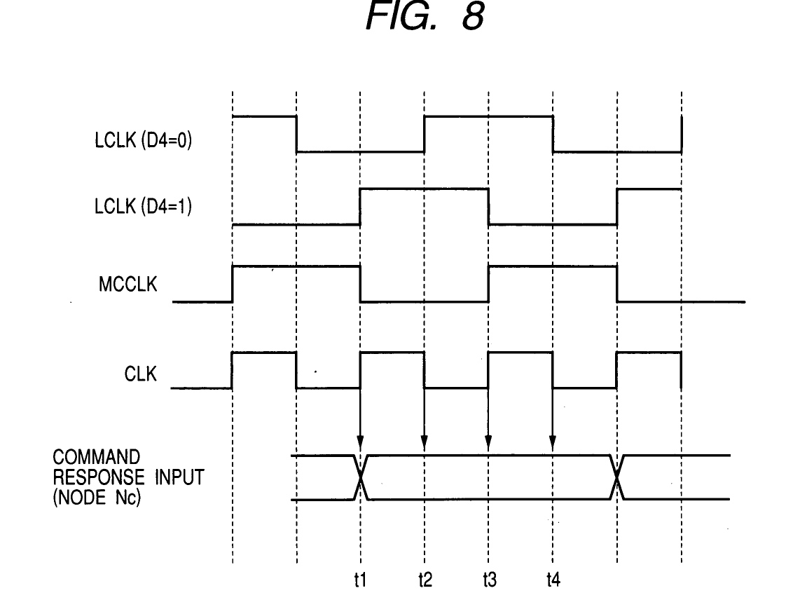

FIG. 8 is a timing chart presenting typical operation timings in effect when the timing switching circuit 12A of FIG. 7 is used. If synchronism with the raising edge (D1=1) is selected where D4=1, a command response is acquired at time t1; if synchronism with the falling edge (D1=0) is selected where D4=1, the command response is acquired at time t3; if synchronism with the raising edge (D1=1) is selected where D4=0, the command response is acquired at time t2; if synchronism with the falling edge (D1=0) is selected where D4=0, the command response is acquired at time t4. This arrangement expands the scope of selectable acquisition timings. Although not shown, similar arrangements may be adopted for the data MCDAT/MCRxD as well.

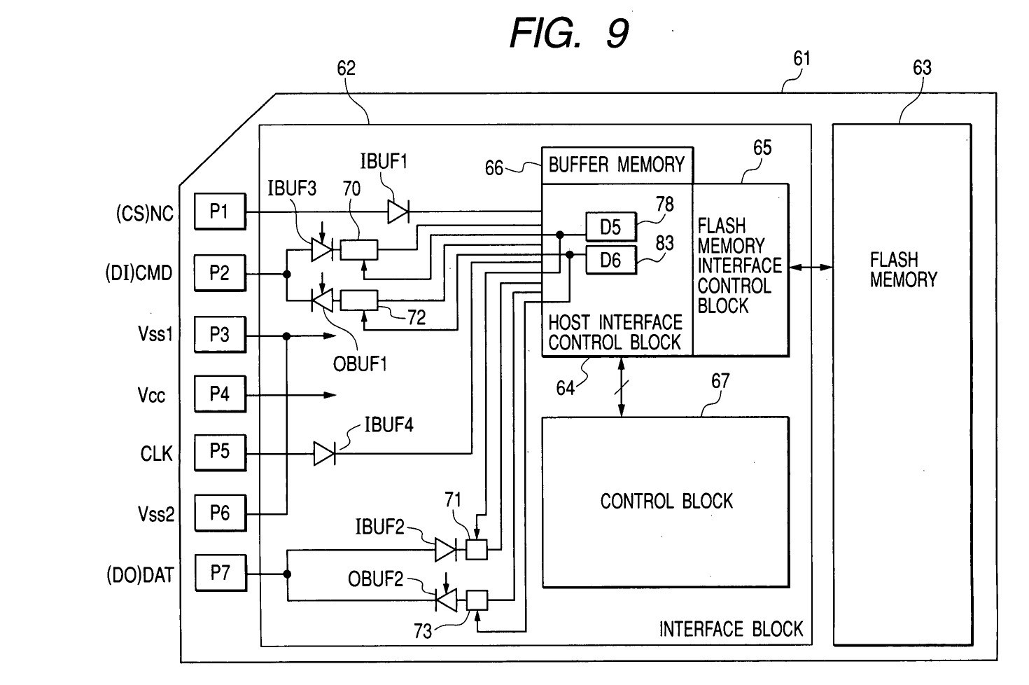

FIG. 9 is a block diagram of an M card 61 as another memory card embodying this invention. The external interface function and the command response function of the M card 61 are basically the same as those of the M card 10 described above. The M card 16 is structured basically as follows: it is a card substrate measuring 1.4 mm by 24 mm by 32 mm. The terminal side of the card has seven external terminals P0 through P6, spaced at equal distances. The external terminals P0 through P6 are connected to an interface block 62 which in turn is connected to a flash memory 63 acting as a rewritable nonvolatile memory.

The flash memory 63, not shown in detail, may be constituted illustratively by floating gate-type nonvolatile memory cells whose threshold voltage is controlled based on the amount of stored charges or on polarity; or by local charge trapping-type nonvolatile memory cells such as MONOS (metal oxide nitride oxide semiconductors) which retain information depending on where charges are trapped with regard to source-drain electrodes. The number of bits for information storage per memory cell is not limited to two. A multi-valued arrangement may also be adopted such as four bits per cell.

The interface block 62 comprises a host interface control block 64 of the M card 61, a flash memory interface control block 65, a buffer memory 66, and a control block 67 for controlling these components. The control block 67 is constituted illustratively by a single-chip microcomputer. Between the host interface control block 64 on the one hand and the external terminals P0 through P6 on the other hand, there are input buffers IBUF1 through IBUF4 and output buffers OBUF1 and OBUF2 interposed in a manner matching the terminal functions. Downstream of the input buffers IBUF3 and IBUF2 are signal acquisition timing switching circuits 70 and 71 respectively. Transmission timing switching circuits 72 and 73 are located upstream of the output buffers OBUF1 and OBUF2 respectively. As with the M card 10 mentioned above, the M card 61 has MMC mode and SPI mode.

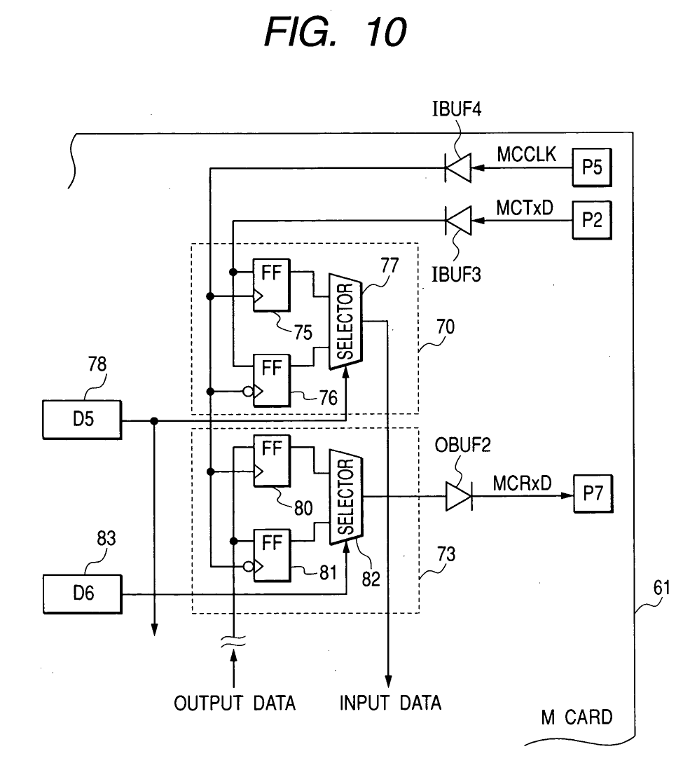

FIG. 10 is a circuit diagram of the signal acquisition timing switching circuit 70 and transmission timing switching circuit 73. The signal acquisition timing switching circuit 70 is made up of latch circuits 75 and 76 and a selector 77, and is capable of acquiring input data MCTxD in synchronism with a raising edge or a falling edge of the clock signal MCCLK. One of the two edge types of the clock signal is determined by control data D5 set in a control register 78. The transmission timing switching circuit 73 is composed of latch circuits 80 and 81 and a selector 82, and is capable of acquiring output data MCRxD in synchronism with a raising edge or a falling edge of the clock signal MCCLK. Either of the two edge types of the clock signal is determined by control data D6 set in a control register 83. Although not shown, the other switching circuits 71 and 72 are also structured likewise.

The memory card host device sets the control data D5 and D6 in the control registers 78 and 83. In other words, the control registers 78 and 83, as with the other control registers of the M card 61, may have their control data set when accessed by the host in accordance with an externally supplied register access command.

The above-described M card 61 is thus structured to incorporate the necessary arrangements for adjusting the signal acquisition and transmission timings in response to data errors. The memory card host device need only have an appropriate control program for detecting data errors and setting suitable control data based on the detected errors.

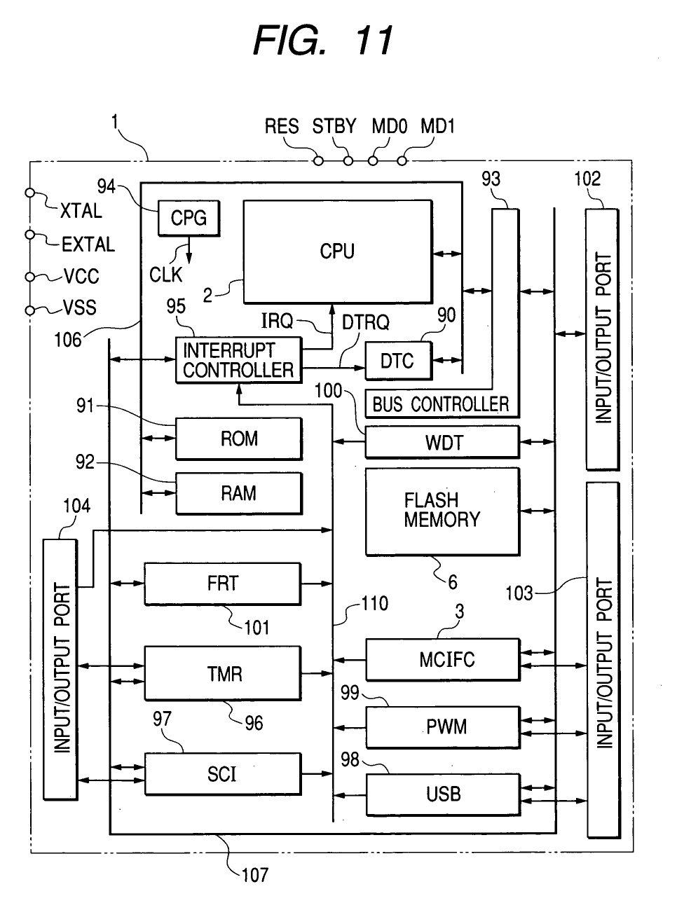

FIG. 11 is an overall block diagram showing the data processor 1 in more detail. As illustrated, the data processor 1 comprises: a central processing unit (CPU) 2, a data transfer controller (DTC) 90, a read-only memory (ROM) 91, a random access memory (RAM) 92 which serves as a work area of the CPU 2 and which is used to retain data temporarily, a flash memory 6 that stores the control program of the CPU 2 and other resources, a bus controller 93, a clock pulse generation circuit (CPG) 94, an interrupt controller 95, a timer counter (TMR) 96, a serial communication interface controller (SCI) 97, a universal serial bus controller (USB) 98, an MCIFC 3, a pulse-width modulator (PWM) 99, a watchdog timer (WDT) 100, a free-running timer (FRT) 101, and input/output ports 102 through 104. A CPU bus 106 is connected to the CPU 2, DTC 90, ROM 91, RAM 92, and bus controller 93. The CPU bus 106 is interfaced to a peripheral bus 107 through the bus controller 93. The peripheral bus 107 is connected to such peripheral circuits as the interrupt controller 95, TMR 96, SCI 97, USB 98, MCIFC 3, PWM 99, and WDT 100. Each of the CPU bus 106 and peripheral bus 107 includes a data bus, an address bus and a control signal bus, and thus corresponds to the bus 5 discussed above. The peripheral bus 107 is interfaced to an external bus (not shown) through the input/output port 102. The CPU bus 106 is interfaced to the peripheral bus 107 through the bus controller 93, and to the external bus through the input/output port 102. The input/output ports 103 and 103 function as external interface buffers for the peripheral circuits.

In the data processor 1, the CPU 2 and DTC 90 constitute a bus master module each. The CPU 2 has an instruction control block and an execution block. The instruction control block fetches instructions illustratively from the ROM 91 or flash memory 6 and interprets the fetched instructions. The execution block carries out arithmetic processing using general registers and an arithmetic and logic unit in accordance with the result of instruction interpretation by the instruction control block. Data transfer control conditions for the DTC 90 are set in advance to the RAM 92 by the CPU 2. When the FRT 101 issues a data transfer request, the corresponding data transfer control condition is loaded from the RAM 92 to the DTC 90. In turn, the DTC 90 executes data transfer control in keeping with the loaded transfer control condition.

The bus controller 93 arbitrates the contention in bus right requests among the bus master modules of the CPU 2 and DTC 90 and an external bus master. The logic of arbitration is illustratively based on the order of priorities. One of the bus master modules outputs a bus command when granted the bus right as a result of arbitration. The bus controller 93 controls the bus in accordance with the output bus command. If an address signal output by any bus master module designates an external address space of the data processor 1, the bus controller 93 outputs the address signal and an access strobe signal to the outside via the input/output port 102.

The interrupt controller 95 is supplied with an internal interrupt signal output by such peripheral circuits as the FRT 101 connected to the peripheral bus 107, and with an external interrupt signal that is input from the outside through the input/output port 104. The internal and external interrupt signals are represented generically by the signal 110 in FIG. 11. The interrupt controller 95 carries out priority control and mask control on input interrupt signals before handling these interrupt requests. When servicing an interrupt, the interrupt controller 95 outputs an interrupt request signal IRQ to the CPU 2 or a DTC start request signal DTRQ to the DTC 90 depending on the type of the interrupt request signal.

Upon receipt of the interrupt request signal IRQ, the CPU 2 interrupts the ongoing processing and branches to a suitable interrupt handling routine in accordance with the cause of interruption. At the end of the interrupt handling routine following the branch, the CPU 2 executes a return instruction in order to resume the interrupted processing.

The data processor 1 also comprises external terminals such as a ground level (VSS) terminal and a supply voltage level (VCC) terminal. In addition, the data processor 1 has dedicated control terminals covering reset input (RES), standby input (STBY), mode control input (MD0, MD1), and clock input (EXTAL, XTAL).

The CPG 94 generates the system clock signal CLK based illustratively on a crystal oscillator connected to the EXTAL and XTAL terminals, or on an external clock signal that is input to the EXTAL terminal.

Feeding a reset signal RES to the data processor 1 brings the on-chip circuit modules such as the CPU 2 into a reset state. When the reset state thus brought about by the reset signal RES is cancelled, the CPU 2 reads instructions from a predetermined start address to start program execution. In so doing, the CPU 2 illustratively fetches data from the RAM 92, processes the fetched data, and exchanges signals with the outside via the MCIFC 3 or the like based on the result of the processing, thereby effecting various device controls.

Although the description above contains many specificities, these should not be construed as limiting the scope of the invention but as merely providing illustrations of some of the presently preferred embodiments of this invention. It is to be understood that changes and variations may be made without departing from the spirit or scope of the claims that follow.

For example, the memory card is not limited to the M card; it may be a memory card pursuant to any other suitable standards. The switching of frequencies is not limited to the two levels of high and low frequencies; switchover may be performed between many more levels of frequencies. The circuit modules incorporated in the data processor are not limited to those discussed above; they may be modified as needed.

The major benefits of this invention are summed up as follows: switchover is made possible between the raising and falling edges of the clock signal for synchronism in acquiring or transmitting signals. It is also possible to switch from one clock signal frequency to another for synchronization. These features combine to eliminate access errors resulting from propagation delays involved in the clock signal and data.

What is claimed is:

1. A data processor comprising:
a central processing unit; and
a memory card interface controller connectable to a clock synchronized memory card,
wherein said memory card interface controller transmits a clock signal to said memory card to acquire read data therefrom in synchronism with said clock signal, said memory card interface controller being switchable between a raising edge and a falling edge of said clock signal when acquiring said read data in synchronous relation with said clock signal.

2. A data processor according to claim 1, wherein said memory card interface controller is switchable between different frequencies of said clock signal.

3. A data processor according to claim 1, wherein said central processing unit switches between the raising edge and the falling edge of the clock signal in response to a data read error during read data acquisition in synchronism with the clock signal.

4. A data processor according to claim 2, wherein said central processing unit switches from a high frequency to a low frequency of the clock signal in response to a data read error.

5. A data processor according to claim 2, wherein said central processing unit switches between the raising edge and the falling edge of the clock signal in response to a data read error during read data acquisition in synchronism with said clock signal, the central processing unit further switching from a high frequency to a low frequency of the clock signal in response to a data read error following the switching between the raising edge and the falling edge of the clock signal.

6. A data processor according to claim 1, wherein said central processing unit switches from a high frequency to a low frequency of the clock signal in response to a data read error, said central processing unit further switching between the raising edge and the falling edge of the clock signal in response to a data read error after the frequency switching during read data acquisition in synchronism with the clock signal.

7. A data processor according to claim 1, further comprising:
a first register accessible by said central processing unit, the first register being loaded with control data for determining whether said read data is to be acquired in synchronism with the raising edge or with the falling edge of said clock signal.

8. A data processor according to claim 2, further comprising:
first and second registers accessible by said central processing unit, said first register being loaded with control data for determining whether said read data is to be acquired in synchronism with the raising edge or with the falling edge of said clock signal, said second register being loaded with control data for determining whether said clock signal is to have a high frequency or a low frequency.

9. A data processor according to claim 8, further comprising:
a nonvolatile memory which is electrically rewritable and which serves as a storage area for accommodating a control program executed by said central processing unit in order to generate said control data.

10. A data processor according to claim 1, wherein said memory card interface controller transmits data to said memory card in synchronism with the clock signal, said memory card interface controller being switchable between the raising edge and the falling edge of said clock signal when transmitting the data in synchronous relation with said clock signal.

11. A memory card for receiving a clock signal from a memory card host device and transmitting read data to said memory card host device,
wherein said memory card determines whether to synchronize with a raising edge or with a falling edge of said clock signal when transmitting said read data.

12. A memory card according to claim 11, wherein said memory card host device instructs said memory card to determine whether to synchronize with the raising edge or with the falling edge of said clock signal.

13. A memory card according to claim 11, wherein said memory card acquires data from the memory card host device in synchronism with said clock signal, said memory card further determining whether to synchronize with the raising edge or with the falling edge of said clock signal when acquiring said data.
